(19) United States
(12) Patent Application Publication
(10) Pub. No.: US 2017/0305665 A1
(43) Pub. Date: Oct. 26, 2017

(54) RECEPTACLE, RECEPTACLE STABILIZER, AND RELATED METHODS

(71) Applicant: Aaron R. Baugh, West Jordan, UT (US)

(72) Inventor: Aaron R. Baugh, West Jordan, UT (US)

(21) Appl. No.: 15/484,698

(22) Filed: Apr. 11, 2017

Related U.S. Application Data
(60) Provisional application No. 62/326,768, filed on Apr. 24, 2016.

(51) Int. Cl. B65F 1/14; B29C 51/10; B65F 1/16; B65F 1/02; B29K 55/02

(52) U.S. Cl. CPC B65F 1/14; B65F 1/1473; B65F 1/02; B29C 51/10; B65F 1/16; B29K 2055/02; B65F 2250/112; B65F 2250/1146

(57) ABSTRACT

A receptacle stabilizer for stabilizing a receptacle may include a cover portion defining a cavity and at least one weight portion disposed within the cavity of the cover portion. The cover portion may include a top wall, a plurality of sidewalls extending downward from the top wall, and a lip portion extending outward from the plurality of sidewalls. The cavity may be defined between the top wall and the plurality of side walls. A method of forming a receptacle stabilizer may include heating a material to be formed into a cover portion of the receptacle stabilizer, placing the heated material over a mold, vacuum forming the heated material into the mold and forming the cover portion, and disposing at least one weight portion into a cavity of the cover portion.

### CROSS-REFERENCE TO RELATED APPLICATION(S)

This application claims priority to U.S. Provisional Patent Application No. 62/326,768 filed Apr. 24, 2016, the disclosure of which is incorporated in its entirety by reference herein.

### TECHNICAL FIELD

Embodiments of the present disclosure relate generally to receptacle stabilizers.

### BACKGROUND

Receptacles such as, for example, trashcans and recycling receptacles tend to be susceptible to being tipped over relatively easy by wind or animals (e.g., dogs trying to eat trash). When receptacles are tipped over, trash is often spread out by the wind and/or animals resulting a substantial mess to clean up and, in some cases, additional work for utility employees and users. However, in order for the receptacles to be useable with conventional garbage and recycling trucks, the receptacles cannot be attached to the ground because such a solution would prevent the receptacles from being lifted and unloaded by the trucks. Furthermore, to be useable by a typical user (e.g., person) and the receptacles cannot be overly heavy.

### BRIEF SUMMARY

Some embodiments of the present disclosure include a receptacle stabilizer for stabilizing a receptacle. The receptacle stabilizer may include a cover portion defining a cavity and at least one weight portion disposed within the cavity of the cover portion.

Some embodiments of the present disclosure include a receptacle. The receptacle may include a bottom wall and a receptacle stabilizer. The receptacle stabilizer may be attached to a top surface of the bottom wall. The receptacle stabilizer may include a cover portion and at least one weight portion. The cover portion may include a top wall extending in a first plane, a plurality of sidewalls extending downward from the top wall, a cavity defined between the top wall and the plurality of sidewalls, and a lip portion extending outward from the plurality of sidewalls on an end of the sidewalls opposite the top wall. The lip portion may extend outward in a second plane that is at least substantially parallel to the first plane and may abut up against the top surface of the bottom wall of the receptacle. The at least one weight portion may disposed within the cavity of the cover portion and may be disposed between the top wall of the cover portion and the bottom wall of the receptacle.

Some embodiments of the present disclosure include a method of forming a receptacle stabilizer. The method may include heating a material to be formed into a cover portion of the receptacle stabilizer, placing the heated material over a mold, vacuum forming the heated material into the mold and forming the cover portion, and disposing at least one weight portion into a cavity of the cover portion.

### BRIEF DESCRIPTION OF THE DRAWINGS

FIG. 1 is a perspective view of a receptacle having a receptacle stabilizer disposed therein according to an embodiment of the present disclosure;

FIG. 2A is a partial side cross-sectional view of a receptacle stabilizer attached to a receptacle according to an embodiment of the present disclosure;

FIG. 2B is a partial perspective view of the receptacle stabilizer of FIG. 2A; and

FIG. 3 is a flow chart of a method of forming a receptacle stabilizer according to an embodiment of the present disclosure;

FIG. 4 is a partial side cross-sectional view of a receptacle stabilizer attached to a receptacle according to another embodiment of the present disclosure; and

FIG. 5 is partial side cross-sectional view of a receptacle stabilizer attached to a receptacle according to another embodiment of the present disclosure.

### DETAILED DESCRIPTION

The illustrations presented herein are not meant to be actual views of any particular device, but are merely idealized representations, which are employed to describe example embodiments of the present disclosure.

As used herein, any relational term, such as “first,” “second,” “over,” “beneath,” “top,” “bottom,” “underlying,” “upward,” “downward,” etc., is used for clarity and convenience in understanding the disclosure and accompanying drawings, and does not connote or depend on any specific preference, orientation, or order, except where the context clearly indicates otherwise. For example, these terms may refer to an orientation of elements of the receptacle stabilizer relative to a bottom surface of an interior of a receptacle (e.g., a trashcan) in which the receptacle stabilizer may be positioned, installed, and/or used (e.g., as illustrated in the figures).

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

Some embodiments of the present disclosure include a receptacle stabilizer for providing additional stability to a receptacle such as, for example, a trashcan, green waste receptacle, and/or recycling receptacle. As used herein, the phrases “providing additional stability” to a receptacle and “provide stability” to a receptacle and their equivalents mean reducing a propensity (e.g., likelihood) of the receptacle tipping over due to outside influences such as, for example, wind. For example, the receptacle stabilizer may reduce the likelihood of a receptacle being tipped over when subjected to wind. In other words, the receptacle stabilizer may increase an amount of force required to tip over the receptacle and, as a result, an amount or strength of wind required to tip over the receptacle. Furthermore, the receptacle stabilizer may help to prevent a receptacle from (e.g., reduce a likelihood of a receptacle) tipping over due to animals or lopsided items (e.g., trash) within the receptacle. The receptacle stabilizer may include a cover portion and an at least one weight portion. The cover portion may define a cavity and the at least one weight portion may be disposed within the cavity. The cover portion may be installed (e.g., attached) to a bottom wall of the receptacle (e.g., floor of the trashcan). The cover portion may hold the at least one weight portion between the cover portion and the bottom wall of the receptacle. In some embodiments, the receptacle stabilizer may include two or more weight portions. In some embodiments, the receptacle stabilizer may include three or more weight portions. In some embodiments, the receptacle stabilizer may include four or more weight portions.

Some embodiments of the present disclosure include a method of making a receptacle stabilizer. The method may include heating a material to be formed into a cover portion of the receptacle stabilizer, vacuum forming the material into a mold to form the cover portion, and disposing at least one weight portion into cover portion.

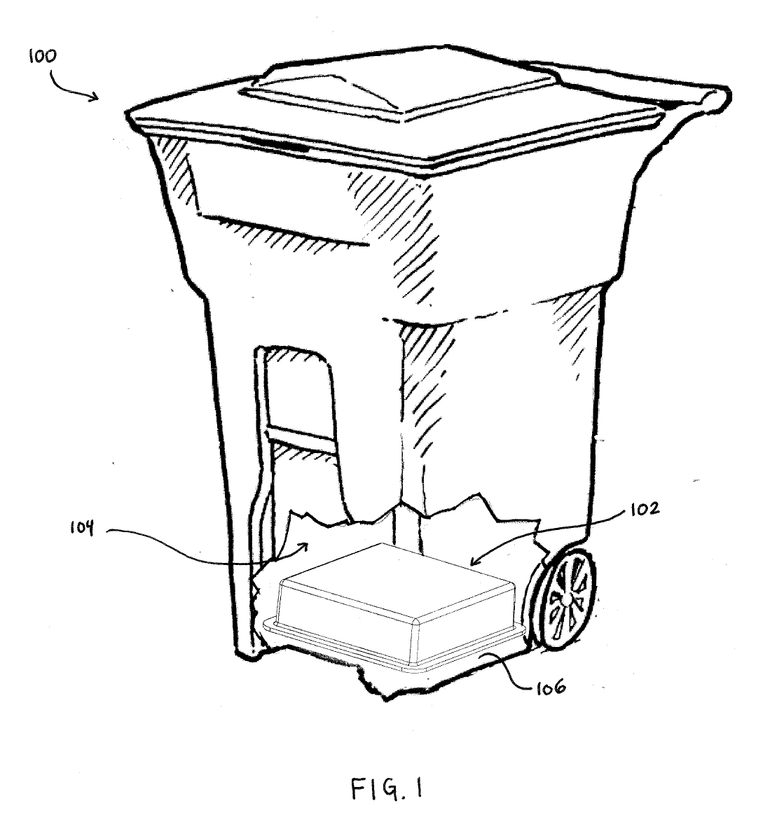

FIG. 1 is a perspective view of a receptacle 100 (e.g., a trashcan) having a receptacle stabilizer 102 disposed therein and with portions of the receptacle 100 removed to better show the elements of the receptacle stabilizer 102. For example, the receptacle stabilizer 102 may be disposed within an interior 104 of the receptacle 100 and may be attached to a bottom wall 106 (e.g., floor) of the receptacle 100.

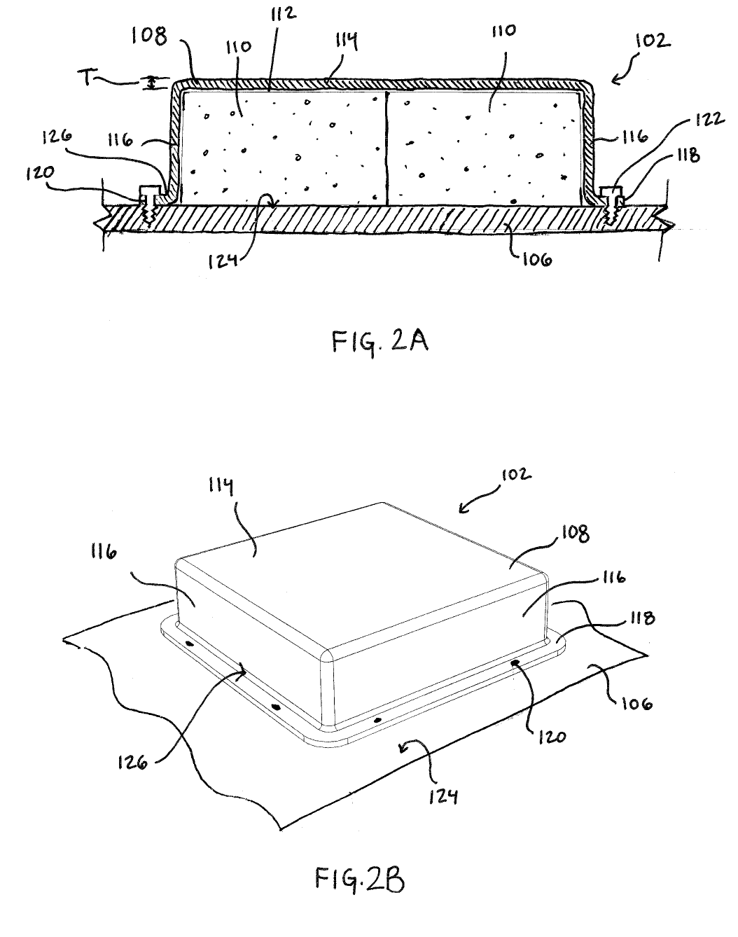

FIG. 2A is a side cross-sectional view of a receptacle stabilizer 102 attached to a bottom wall 106 of a receptacle 100 according to an embodiment of the present disclosure. FIG. 2B is an enlarged perspective view of the receptacle stabilizer 102 attached to the bottom wall 106 of the receptacle 100. Referring to FIGS. 1, 2A, and 2B together, the receptacle stabilizer 102 may include a cover portion 108 and at least one weight portion 110. The cover portion 108 may define a cavity 112 (e.g., may be hollow) and may include a top wall 114, at least one sidewall 116, a lip portion 118, a plurality of holes 120, and a plurality of fasteners 122. The top wall 114 may extend within a first plane, and the first plane may be at least substantially horizontal when the receptacle stabilizer 102 is installed within a receptacle 100 and the receptacle 100 is oriented in an upright position (e.g., position shown in FIG. 1). The at least one sidewall 116 of the cover portion 108 may extend downward from the top wall 114, and the top wall 114 and the at least one sidewall 116 may at least partially define the cavity 112. For example, in some embodiments, the cavity 112 may be defined between a plurality of opposing sidewalls 116 and the top wall 114 of the cover portion 108. For example, in some embodiments, the at least one sidewall 116 may include four sidewalls 116, and each sidewall 116 of the four sidewalls 116 may extend downward from a respective edge of a rectangular shaped top wall 114, as shown in FIG. 1. In other words, the cover portion 108 may have a generally rectangular prism shape. In such embodiments, the cavity 112 may be defined between the four sidewalls 116 and the top wall 114.

The lip portion 118 may extend outward from the at least one sidewall 116 of the cover portion 108 and may extend outward in a direction at least substantially perpendicular to an exterior surface of the at least one sidewall 116. For example, when the receptacle stabilizer 102 is attached to the bottom wall 106 of a receptacle 100, the lip portion 118 may extend in a direction at least substantially parallel to a top surface 124 of the bottom wall 106 (e.g., floor) of the receptacle 100. Furthermore, the lip portion 118 may extend outward in a second plane that is at least substantially parallel the first plane in which the top wall 114 of the cover portion 108 extends. The lip portion 118 may abut up against the top surface 124 of the bottom wall 106 of the receptacle 100 when the receptacle stabilizer 102 is disposed within the receptacle 100 and attached to the bottom wall 106 of the receptacle 100. In some embodiments, an interface 126 of the lip portion 118 and the at least one sidewall 116 may be at least substantially rounded. In other words, the interface 126 of the lip portion 118 and the at least one sidewall 116 may not form a sharp corner (e.g., edge). By not forming a sharp corner at the interface 126 of the lip portion 118 and the at least one sidewall 116, stress concentrators (e.g., sudden changes in geometry) may be avoided, and as a result, an overall integrity and strength of the cover portion 108 may be improved.

The plurality of holes 120 may extend through the lip portion 118 and may be sized and shaped to receive to the plurality of fasteners 122. The plurality of fasteners 122 may be configured to attach the cover portion 108 of the receptacle stabilizer 102 to the bottom wall 106 (e.g., floor) of the receptacle 100. For example, when the receptacle stabilizer 102 is attached to the bottom wall 106 of the receptacle 100, the fasteners 122 may extend through the plurality of holes 120 and may extend at least partially into the bottom wall 106 of the receptacle 100 and may attach the cover portion 108 to the bottom wall 106 of the receptacle 100 through mechanical interference between the plurality of fasteners 122, the cover portion 108 of the receptacle stabilizer 102, and the bottom wall 106 of the receptacle 100. The plurality of fasteners 122 may include any suitable fastener such as, for example, screws, rivets, bolts, nuts, etc. In some embodiments, the lip portion 118 may not include the plurality of holes 120, and the cover portion 108 may be attached to the bottom wall 106 of the receptacle 100 via an adhesive instead of the plurality of fasteners 122. In other embodiments, the cover portion 108 may be attached to the bottom wall 106 of the receptacle 100 via both the plurality of fasteners 122 and an adhesive. The adhesive may help to seal an interface 126 between the cover portion 108 of the receptacle stabilizer 102 and the bottom wall 106 of the receptacle 100 and may help to prevent anything (e.g., trash, liquids, sludge) from unintentionally entering into the cavity 112 of the cover portion 108 when in use.

Furthermore, although the cover portion 108 is described herein as having a generally rectangular prism shape, the cover portion 108 may include any hollow geometric shape. For example, the cover portion 108 may have a cylindrical shape, cubic shape, dome shape, triangular shape, or any other geometric shape defining a cavity 112 therein.

In some embodiments, the cover portion 108 may include one or more of a polymeric material, rubber material, and metallic material. For example, in some embodiments, the cover portion 108 may include acrylonitrile butadiene styrene (“ABS Plastic”). In other embodiments, the cover portion 108 may include polybutylene. In some embodiments, the cover portion 108 may include one or more of polypropylene, melamine, nylon, polycarbonate, and polyvinyl chloride. In other embodiments, the cover portion 108 may include a metallic material such as, for example, aluminum.

In some embodiments, the cover portion 108 may include a single uniform body. In other words, the cover portion 108 may be formed from a single piece of material. In other embodiments, the cover portion 108 may include a plurality of pieces of material attached together. For example, in some embodiments, the top wall 114 and at least one sidewall 116 may be formed from different pieces of material and then may be attached together.

The cavity 112 defined by the cover portion 108 may be sized and shaped to receive the at least one weight portion 110 therein. When attached to the bottom wall 106 of the receptacle 100, the cover portion 108 may hold the at least one weight portion 110 between the cover portion 108 and the bottom wall 106 of the receptacle 100. In some embodiments, the at least one weight portion 110 may not be secured to (e.g., may be loose within) the cover portion 108. In other embodiments, the at least one weight portion 110 may be secured within the cavity 112 of the cover portion 108. For example, the at least one weight portion 110 may be secured within the cavity 112 of the cover portion 108 through an interference fit.

In some embodiments, the at least one weight portion 110 may have a shape at least generally similar to the cavity 112 defined by the cover portion 108. Having the shape of the at least one weight portion 110 be at least generally similar to the shape of the cavity 112 may reduce an amount that the at least one weight portion 110 moves within the cavity 112 of the cover portion 108. Reducing an amount that the at least one weight portion 110 moves within the cavity 112 may help to prevent the at least one weight portion 110 from inadvertently damaging the cover portion 108 during use.

In some embodiments, the at least one weight portion 110 may include at least two weight portions 110. In other embodiments, the at least one weight portion 110 may include at least three weight portions 110. In other embodiments, the at least one weight portion 110 may include at least four weight portions 110. In other embodiments, the at least one weight portion 110 may include at least five weight portions 110. In embodiments including a plurality of weight portions 110, the cavity 112 may be sized and shaped to receive the plurality of weight portions 110.

By having different numbers of weight portions 110, the receptacle stabilizer 102 can easily be selected to accommodate different sizes of receptacles. Receptacles are often made in different sizes, and thus, may require different amounts of weight to properly stabilize the receptacle 100. For example, receptacles are made in 24-gallon, 32-gallon, 48-gallon, 64-gallon, and 96-gallon sizes. Depending on the size of the receptacle 100, a receptacle stabilizer 102 having an appropriate number of weight portions 110 may be selected to stabilize the receptacle 100. For example, a 24-gallon receptacle 100 and a 32-gallon receptacle 100 may each be stabilized with a receptacle stabilizer 102 having one weight portion. A 48-gallon receptacle 100 may be stabilized with a receptacle stabilizer 102 having two to three weight portions 110. A 64-gallon receptacle 100 may be stabilized with a receptacle stabilizer 102 having three to four weight portions 110. A 96-gallon receptacle 100 may be stabilized with a receptacle stabilizer 102 having four to five weight portions 110.

In some embodiments, the at least one weight portion 110 may include a relatively dense material. For example, the at least one weight portion 110 may include one or more of concrete, rock, brick, metal (e.g., steel, iron), lead, sand, or any other relatively dense material. In some embodiments, the at least one weight portion 110 may include one or more of a brick, slab, and plate of material. In some embodiments, a weight of at least one weight portion 110 may be within a range of about 3 lbs. (1.36 kg) and about 15 lbs. (6.80 kg). In other embodiments, a weight of at least one weight portion 110 may be within a range of about 5 lbs. (2.27 kg) and about 10 lbs. (4.54 kg). For example, the at least one weight portion 110 may weigh about 5 lbs. In embodiments including a plurality of weight portions 110, each weight portion of the plurality of weight portions 110 may be about 5 lbs. (2.27 kg) or within any of the above described ranges of weights.

The cover portion 108 may have a thickness T (e.g., a thickness of the material of which the cover portion 108 is made) within a range of about 0.10 inch (0.254 cm) and about 1.50 inch (3.81 cm). In some embodiments, the cover portion 108 may have a thickness T within a range of about 0.10 inch (0.254 cm) and about 0.75 inch (1.91 cm). In some embodiments, the cover portion 108 may have a thickness T within a range of about 0.10 inch (0.254 cm) and about 0.25 inch (0.635 cm). For example, the cover portion 108 may have a thickness T of about 0.177 inch (0.45 cm). As another example, the cover portion 108 may have a thickness T of about 0.118 inch (0.30 cm).

In embodiments having two weight portions 110, the top wall 114 of the cover portion 108 may have a first length of about 8.05 inches (20.45 cm) and a second length, perpendicular to the first length, of about 8.05 inches (20.45 cm). Furthermore, for each additional weight portion included in the receptacle stabilizer 102, the first length may be increased by about 4.0 inches (10.2 cm). For example, in embodiments having three weight portions 110, the top wall 114 of the cover portion 108 may have a first length of about 12.0 inches (30.5 cm) and a second length of about 8.05 inches (20.5 cm).

The lip portion 118 may extend outward from the at least one sidewall 116 by a distance within a range of about 1.0 inch (2.54 cm) to about 2.0 inches (5.08 cm). For example, the lip portion 118 may extend radially outward from the at least one sidewall 116 by about 1.44 inches (3.66 cm). The lip portion 118 may extend outward from the at least one sidewall 116 within the second plane that is at least substantially parallel to the first plane in which the top wall 114 of the cover portion 108 extends.

A bottom surface 128 of the top wall 114 (e.g., a surface of the top wall 114 within the cavity 112) may be separated from the bottom wall 106 of the receptacle 100, when installed within the receptacle 100, by a distance within a range of about 1.5 inches (3.81 cm) to about 3.5 inches (8.89 cm). For example, the bottom surface 128 of the top wall 114 may be separated from the bottom wall 106 of the receptacle 100 by a distance of about 2.6 inches (6.60 cm).

In some embodiments, an overall height of the cover portion 108 may be within a range of about 2.5 inches (6.35 cm) to about 4.0 inches (10.2 cm). For example, in some embodiments, the overall height of the cover portion 108 may be about 2.8 inches (7.11 cm). In some embodiments, an overall depth of the cavity 112 measured from a surface of the lip portion 118 intended to abut up against the bottom wall 106 of the receptacle 100 (e.g., a bottom surface of the cover portion 108) may be within a range of about 1.5 inches (3.81 cm) to about 3.5 inches (8.89 cm). For example, the overall depth of the cavity 112 may be about 2.6 inches (6.60 cm).

When installed to a bottom wall 106 of a receptacle 100 (e.g., a trashcan, green waste receptacles, recycling receptacles), the receptacle stabilizer 102 may help to prevent the receptacle 100 from unintentionally tipping over. For example, attaching the receptacle stabilizer 102 to a bottom of a receptacle 100 may reduce a likelihood of the receptacle 100 being tipped over unintentionally by, for example, wind, animals, and/or lopsided material (e.g., trash, grass clippings) within the receptacle 100. Furthermore, the receptacle stabilizer 102 does not interfere with, for example, garbage trucks unloading the receptacle 100. For example, the receptacle stabilizer 102 does not require attaching the receptacle 100 in any manner to a ground surface 133, which would likely interfere with, for example, a garbage trucking lifting the receptacle 100 during an unloading procedure. Furthermore, the receptacle stabilizer 102 remains installed within the receptacle 100 even when the receptacle 100 is tilted during an unloading procedure. By remaining installed within the receptacle 100, the receptacle stabilizer 102 provides an advantage over just placing rocks or bricks in a receptacle 100 to stabilize the receptacle 100, which leads to losing the rocks or bricks each time the receptacle 100 is unloaded.

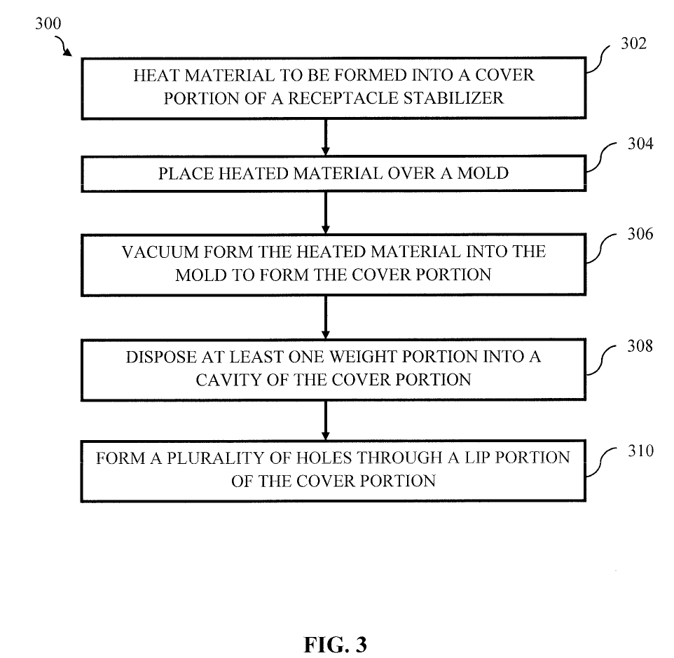

FIG. 3 is a flow chart showing a method 300 of making a receptacle stabilizer 102 (FIG. 1) according to an embodiment of the present disclosure. Referring to FIGS. 1-3 together, the method 300 may include heating a material to be formed into the cover portion 108, as represented by action 302. For example, heating a material to be formed into the cover portion 108 may include heating a sheet of polymeric material or rubber material. For example, heating a material to be formed into the cover portion 108 may include heating a sheet of acrylonitrile butadiene styrene. Furthermore, heating a material to be formed into the cover portion 108 may include heating a virgin polymeric material (e.g., a plastic that has only been heated once before). By using a virgin plastic, more integrity of the plastic is retained when heating and a more durable (e.g., robust, strong, sturdy) cover portion 108 is produced. The material may be heated through any known methods. In some embodiments, the material may be heated to a temperature within a range of about 250° F. (121° C.) to about 320° F. (160° C.). Furthermore, the material may be heated to a forming temperature, which is known in the art. For example, in some embodiments, the material may be heated to about 305° F. (152° C.).

Once heated, the material may be placed over a mold, as represented in action 304. After being placed over the mold, the material may be vacuum formed into the mold and into a shape of the cover portion 108, as described above, and as represented by action 306. The material may be vacuum formed through any known method.

Once formed, at least one weight portion 110 may be disposed within a cavity 112 of the cover portion 108, as represented by action 308. Disposing at least one weight portion 110 within the cavity 112 may include disposing one, two, three, four, five, or more weight portions 110 within the cavity 112 of the cover portion 108. Furthermore, in some embodiments, disposing at least one weight portion 110 within the cavity 112 may include disposing a concrete brick within the cavity 112 of the cover portion 108. In some embodiments, the at least one weight portion 110 may be secured within the cavity 112 of the cover portion 108 through an interference fit.

In some embodiments, a plurality of holes 120 may be formed in a lip portion 118 of the cover portion 108, as represented in action 310. Furthermore, the cover portion 108 and the at least one weight portion 110 may be installed within a receptacle 100 by placing a plurality of fasteners 122 through the plurality of holes 120 and engaging the fasteners 122 with a bottom wall 106 of the receptacle 100.

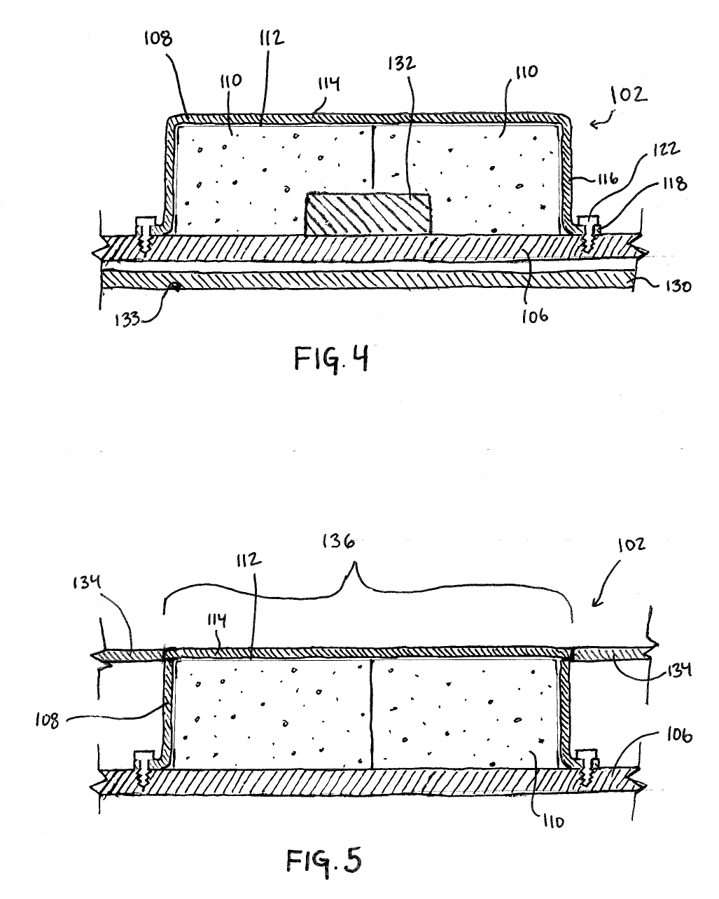

FIG. 4 is a side cross-sectional view of a receptacle stabilizer 102 according to another embodiment of the present disclosure. Referring to FIGS. 1 and 4 together, in some embodiments, the receptacle stabilizer 102 may further include a mounting plate 130 and at least one magnet 132. In some embodiments, the at least one weight portion 110 may include the magnet 132. In other words, the magnet 132 may be disposed within the cavity 112 of the cover portion 108 and proximate the bottom wall 106 of the receptacle 100. The mounting plate 130 may include a ferrous material and may be configured to be mounted (e.g., attached) to a ground surface 133 where a user would prefer a receptacle 100 to be located during use. Furthermore, the mounting plate 130 may be disposed on a side of the bottom wall 106 of the receptacle 100 opposite the cover portion 108 of the receptacle stabilizer 102. When the receptacle 100 is placed on the mounting plate 130, the mounting plate 130 may be attracted through magnetism to the magnet 132 and may provide additional stability to the receptacle 100. For example, the magnet 132 and mounting plate 130 may provide additional stability to the receptacle 100 when the receptacle 100 is stored (e.g., during the week before “garbage day”), and on “garbage day,” when the receptacle 100 is placed out on the street, the receptacle 100 is stabilized by the receptacle stabilizer 102 through weight only.

FIG. 5 is a side cross-sectional view of a receptacle stabilizer 102 according to another embodiment of the present disclosure. Referring to FIGS. 1 and 5 together, in some embodiments, the receptacle stabilizer 102 may further include a top plate 134 extending outward from the top wall 114 of the cover portion 108 and a door 136 in the top wall 114 of the cover portion 108. A top surface of the top plate 134 may be coplanar with a top surface of the top wall 114 of the cover portion 108. Furthermore, an outer periphery of the top plate 134 may be proximate to an interior surface of a sidewall of the receptacle 100. The top plate 134 may serve as a false bottom for the receptacle 100 and may help to prevent, for example, trash from being caught on the receptacle stabilizer 102 and not being unloaded during and unloading procedure. As a result, the top plate 134 may help keep the receptacle 100 cleaner. Furthermore, the top plate 134 may provide a more cosmetically pleasing appearance. The door 136 may be movably coupled to the top wall 114 and may be openable and may allow at least one weight portion 110 to be inserted into the cavity 112 of the cover portion 108 and, if desired, removed from the cavity 112 of the cover portion 108 through the door 136.

In some embodiments, the top plate 134 may comprising another lip portion, which may allow for receptacle stabilizers 102 to be stacked on top of each other within a receptacle 100. For example, a first receptacle stabilizer 102 may be disposed within the receptacle 100 and attached to the bottom wall 106 of the receptacle 100, and a second receptacle 102 stabilizer may be disposed on top of the first receptacle stabilizer 102 and attached to the another lip portion of the first receptacle stabilizer 102.

While certain illustrative embodiments have been described in connection with the figures, those of ordinary skill in the art will recognize and appreciate that the scope of this disclosure is not limited to those embodiments explicitly shown and described herein. Rather, many additions, deletions, and modifications to the embodiments described herein may be made to produce embodiments within the scope of this disclosure, such as those hereinafter claimed, including legal equivalents. In addition, features from one disclosed embodiment may be combined with features of another disclosed embodiment while still being within the scope of this disclosure, as contemplated by the inventor.

What is claimed is:

1. A receptacle stabilizer for stabilizing a receptacle, comprising:
a cover portion defining a cavity;
at least one weight portion disposed within the cavity of the cover portion.

2. The receptacle stabilizer of claim 1, wherein the cover portion comprises:
a top wall extending in a first plane;
a plurality of sidewalls extending downward from the top wall, wherein the cavity is defined between the top wall and the plurality of sidewalls; and
a lip portion extending outward from the plurality of sidewalls on an end of the plurality of sidewalls opposite the top wall, the lip portion extending outward in a second plane that is at least substantially parallel to the first plane.

3. The receptacle stabilizer of claim 1, wherein the at least one weight portion comprises concrete.

4. The receptacle stabilizer of claim 1, wherein the at least one weight portion comprises a metallic material.

5. The receptacle stabilizer of claim 1, wherein the cover portion comprises a polymeric material.

6. The receptacle stabilizer of claim 5, wherein the cover portion comprises acrylonitrile butadiene styrene.

7. The receptacle stabilizer of claim 1, wherein the cover portion has a thickness within a range of about 0.110 inch to about 0.25 inch.

8. The receptacle stabilizer of claim 1, wherein the at least one weight portion has a weight within a range of about 3 lbs. to about 15 lbs.

9. The receptacle stabilizer of claim 1, wherein the at least one weight portion comprises a plurality of weight portions.

10. A receptacle, comprising:
a bottom wall; and
a receptacle stabilizer attached to a top surface of the bottom wall, the receptacle stabilizer comprising:
a cover portion, comprising:
a top wall extending in a first plane;
a plurality of sidewalls extending downward from the top wall;
a cavity defined between the top wall and the plurality of sidewalls; and
a lip portion extending outward from the plurality of sidewalls on an end of the plurality of sidewalls opposite the top wall, the lip portion extending outward in a second plane that is at least substantially parallel to the first plane and abutting up against the top surface of the bottom wall of the receptacle; and
at least one weight portion disposed within the cavity of the cover portion and disposed between the top wall of the cover portion and the bottom wall of the receptacle.

11. The receptacle of claim 10, wherein the cover portion of the receptacle stabilizer further comprises:
a plurality of holes extending through the lip portion in a direction at least substantially orthogonal to the second plane; and
a plurality of fasteners extending through the plurality of holes and engaging the bottom wall of the receptacle.

12. The receptacle of claim 10, further comprising an adhesive disposed between the lip portion of the cover portion and the top surface of the bottom wall of the receptacle.

13. The receptacle of claim 10, wherein the at least one weight portion comprises a plurality of weight portions.

14. The receptacle of claim 10, wherein the receptacle stabilizer further comprises:
a mounting plate configured to be attached to a ground surface and disposed on a side of the bottom wall of the receptacle opposite the cover portion; and
at least one magnet disposed within the cavity of the cover portion of the receptacle stabilizer and proximate the bottom wall of the receptacle.

15. The receptacle of claim 10, further comprising:
a top plate having a top surface coplanar with a top surface of the top wall of the cover portion, the top plate extending radially outward from the top wall of the cover portion, an outer periphery of the top plate being proximate an interior surface of a sidewall of the receptacle; and
a door movably attached to the top wall of the cover portion and sized and shaped to allow the at least one weight portion to be disposed within the cavity of the cover portion through the door.

16. The receptacle of claim 10, wherein the top wall of the cover portion has an at least generally rectangular shape.

17. A method of forming a receptacle stabilizer, comprising:
heating a material to be formed into a cover portion of the receptacle stabilizer;
placing the material over a mold; and
vacuum forming the material into the mold and forming the cover portion.

18. The method of forming a receptacle stabilizer of the claim 17, further comprising disposing at least one weight portion into a cavity of the cover portion.

19. The method of forming a receptacle stabilizer of the claim 17, further comprising disposing a plurality of weight portions into a cavity of the cover portion.

20. The method of forming a receptacle stabilizer of claim 17, wherein heating a material to be formed into a cover portion of the receptacle stabilizer comprises heating a sheet of acrylonitrile butadiene styrene.
